(19) United States
(12) Patent Application Publication
(10) Pub. No.: US 2025/0240660 A1
(43) Pub. Date: Jul. 24, 2025

(54) METHODS AND UE FOR MANAGING SUCCESSFUL PSCELL CHANGE OR ADDITION REPORTS IN A WIRELESS COMMUNICATION NETWORK

(71) Applicant: Samsung Electronics Co., Ltd., Suwon-si (KR)

(72) Inventor: Aby Kanneath ABRAHAM, Karnataka (IN)

(21) Appl. No.: 19/020,185

(22) Filed: Jan. 14, 2025

(30) Foreign Application Priority Data
Jan. 18, 2024 (IN) 202441003644
Jan. 2, 2025 (IN) 2024 41003644

(51) Int. Cl. H04W 24/10; H04W 64/00; H04W 76/27

(52) U.S. Cl. CPC H04W 24/10; H04W 64/003; H04W 76/27

(57) ABSTRACT

The disclosure relates to a fifth-generation (5G) or sixth-generation (6G) communication system for supporting a higher data transmission rate. A method performed by a user equipment (UE) in a wireless communication system, and the UE, are provided. The method includes storing first information on a successful primary secondary cell group (SCG) cell (PSCell) change or addition, transmitting, to a base station, a message including a report for the successful PSCell change or addition, performing a deregistration procedure from a network, and upon the deregistration procedure, discarding the first information on the successful PSCell change or addition.

### CROSS-REFERENCE TO RELATED APPLICATION(S)

This application is based on and claims priority under 35 U.S.C. § 119(a) of an Indian Provisional patent application number 202441003644, filed on Jan. 18, 2024, in the Indian Patent Office, and of an Indian Complete patent application No. 202441003644, filed on Jan. 2, 2025, in the Indian Patent Office, the disclosure of each of which is incorporated by reference herein in its entirety.

### BACKGROUND

### 1. Field

The disclosure relates to wireless communication networks. More particularly, the disclosure relates to methods and systems for managing Successful Primary Secondary Cell Group (SCG) Cell (PSCell) Addition or Change Reports (SPR) relating to self-optimization of random access.

### 2. Description of Related Art

Fifth-generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth-generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

A Fifth-Generation new radio (5G NR) network, known as Next Generation Radio Network (NG-RAN) comprises of a number of NR base stations such as Next Generation Node B (gNBs). The gNBs can be connected to each other through the Xn interface and can connect to various core network elements, such as the Access and Mobility Management Function (AMF), and User Plane Function (UPF). Further, the gNBs can be divided into two physical entities, the Centralized Unit (CU) and the Distributed Unit (DU). The CU provides supports the higher layers of the protocol stack, such as Session Data Application Protocol (SDAP), Packet Data Convergence Protocol (PDCP), and Radio Resource Control (RRC)). The DU supports the lower layers of the protocol stack, such as Radio Link Control (RLC), Medium Access Control (MAC), and the Physical layer. Each gNB can have multiple cells serving many User Equipment (UEs).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for managing successful primary secondary cell group (SCG) cell (PSCell) change or addition or change reports (SPR) in a wireless communication network.

Another aspect of the disclosure is to provide methods and systems for self-optimization (including optimizations for minimization of drive tests) of random access in wireless communication networks like 5th generation (5G) new radio (NR).

Another aspect of the disclosure is to provide methods and systems for sending random access information to the network by a user equipment (UE) in NR.

Another aspect of the disclosure is to provide methods and systems for Self-Organizing Networks (SON) for dual connectivity scenarios, wherein configuration, reporting and releasing the configuration of UE for reporting information related to successful PSCell Addition and Successful PSCell Change is disclosed, and configured to be stored and reported in a report SPR.

Another aspect of the disclosure is to provide methods and systems for handling mnInitiatedPSCellChange or snInitiatedPSCellChange configuration.

Another aspect of the disclosure is to provide methods and systems for discarding SPR based on de-registration.

Another aspect of the disclosure is to provide methods and systems for deciding to report or not report location information in SPR.

Another aspect of the disclosure is to provide methods and systems wherein UE logs locationinformation based on the node which provides ObtainCommonLocation.

Another aspect of the disclosure is to provide methods and systems wherein UE releases sn-InitiatedPSCellChange while receiving another Otherconfig not including sn-InitiatedPSCellChange.

Another aspect of the disclosure is to provide methods and systems wherein UE logging information for the random access and UE based timing advance (TA) acquisition for SCG lower layer-triggered mobility (LTM).

Additional aspects will be set forth in part in the description which follows and, in part, will be apparent from the description, or may be learned by practice of the presented embodiments.

In accordance with an aspect of the disclosure, a method performed by a UE in a wireless communication system is provided. The method includes storing first information on a successful PSCell change or addition, transmitting, to a base station, a message including a report for the successful PSCell change or addition, performing a deregistration procedure from a network, and upon the deregistration procedure, discarding the first information on the successful PSCell change or addition.

In accordance with another aspect of the disclosure, a UE in a wireless communication system is provided. The UE includes a transceiver, and a controller coupled with the transceiver. The controller is configured to store first information on a successful PSCell change or addition, transmit, to a base station, a message including a report for the successful PSCell change or addition, perform a deregistration procedure from a network, and upon the deregistration procedure, discard the first information on the successful PSCell change or addition.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example block diagram depicting the communication of a user equipment (UE) and a network entity for managing successful primary secondary cell group (SCG) cell (PSCell) addition or change reports (SPR) in a wireless communication network, according to an embodiment of the disclosure;

FIG. 2 is an example diagram illustrating the method of Master Node (MN) initiated primary SCG cell (PSCellChange) configuration and reporting, according to an embodiment of the disclosure;

FIG. 3 is an example diagram illustrating the method of MN Initiated PSCellChange configuration handling in the wireless communication network, when the RRC Reconfiguration message is received by the UE, according to an embodiment of the disclosure;

FIG. 4 is an example diagram illustrating the method of secondary node (SN) Initiated PSCellChange configuration handling, according to an embodiment of the disclosure;

FIG. 5 is an example diagram illustrating the method for handling SPR during de-registration, according to an embodiment of the disclosure;

FIG. 6 is an example diagram illustrating the method for handling ObtainCommonLocation, according to an embodiment of the disclosure;

FIG. 7 is an example flow diagram for managing SPR in a wireless communication network, according to an embodiment of the disclosure;

FIG. 8 illustrates a block diagram illustrating a structure of a UE according to an embodiment of the disclosure; and

FIG. 9 illustrates a block diagram illustrating a structure of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

A UE registers to the network to use the services provided by the network. UE may also deregister from the network by sending Deregistration Request, for e.g. when the user switches of the device or moves into the airplane mode or for any other condition decided by the UE implementation. Network may initiate a deregistration, by sending Non-Access Stratum (NAS) message. In other words, the deregistration procedure allows the UE to inform the network that it does not want to access the 5G system (5GS) any longer, and the network to inform the UE that it does not have access to the 5GS any longer or the network to inform the UE that the UE's registered public land mobile network (PLMN) is not allowed to operate at the UE location. The deregistration request by the UE and deregistration request by the network include whether the deregistration applies to the Third-Generation Partnership Project (3GPP) access, to the non-3GPP access, or to both. When the UE is registered to both accesses in the same PLMN, the deregistration message can be sent over any access regardless of the access the deregistration is applied to. The network-initiated deregistration may be initiated if the UE's registered PLMN is not allowed to operate in the present UE location.

In the existing mechanism, there are a large number of algorithms and configuration parameters used in NG-RAN. Identifying the most optimal radio parameters is a very challenging task, and operators traditionally resort to manual techniques like drive tests to identify the parameters. However, such manual parameter tuning is a costly operation as it depends on various factors, including the number of users, the number of neighbors, the maximum throughput in the cell, and the average throughput in the cell. Furthermore, whenever a neighboring gNB is installed or a new service is introduced, many of the manual operations need to be repeated. To address the issue, Third-Generation Partnership Project (3GPP) introduced Self-Organizing Networks (SON) techniques in wireless technologies like NR. SON was first introduced in 3GPP Release 9 in Long Term Evolution (LTE). The SON techniques can be divided into three categories: Self-Configuration, Self-Optimization, and Self-Healing. The SON architecture can be centralized, distributed, or a hybrid solution.

Dual connectivity, or more technically Multi-Radio Dual Connectivity (MR-DC), is specified by 3GPP in specifications such as TS 37.340. The dual connectivity details and measurement gap operations with dual connectivity is provided.

NG-RAN supports Multi-Radio Dual Connectivity (MR-DC) operation, whereby a User Equipment (UE) in RRC_CONNECTED mode is configured to utilize radio resources provided by two distinct schedulers located in two different NG-RAN nodes connected via a non-ideal backhaul. One node provides NR access, while the other provides either Evolved UMTS Terrestrial Radio Access (E-UTRA) or NR access. One node act as the Master Node (MN), and the other acts as the Secondary Node (SN). The MN and SN are connected via a network interface, and at least the MN is connected to the core network.

NG-RAN supports NG-RAN E-UTRA-NR Dual Connectivity (NGEN-DC), wherein a UE is connected to one ng-eNB (an E-UTRA base station capable of connecting to a 5G core) that acts as the MN and one gNB (5G base station) that acts as the SN. NG-RAN supports NR-E-UTRA Dual Connectivity (NE-DC), where the UE is connected to one gNB acting as the MN and one ng-eNB acting as the SN. The MN may move the SCG (Secondary Cell Group) to different states such as deactivated or activated. When carrier aggregation is supported, the secondary cells may also be moved between deactivated and activated states. When a radio link failure occurs in the SCG, the UE sends an RRC message, SCGFailureInformation.

A Primary SCG Cell (PSCell) change can occur due to mobility and may or may not involve a Secondary Node Change (SN change). The Secondary Node Change procedure can be initiated by either the MN or SN and is used to transfer the UE context from a source SN to a target SN while updating the SCG configuration in the UE.

A Conditional PSCell Change (CPC) is defined as a PSCell change executed by the UE when specific execution conditions are met. The UE may be configured with execution conditions, and upon meeting them, the RRC message (e.g., RRC Reconfiguration) is executed for one or more candidate cells. The UE begins evaluating the execution conditions upon receiving the CPC configuration and stops evaluating once a PSCell change is triggered. Both intra-SN CPC without MN involvement and inter-SN CPC initiated by either the MN or SN are supported.

The following principles apply to CPC, the CPC configuration includes the configuration of CPC candidate PSCells and execution conditions and may include the MN configuration for inter-SN CPC. An execution condition may consist of one or two trigger conditions (CPC events A3/A5, as defined in TS 38.331). Only a single RS type is supported, and at most two different trigger quantities (e.g., RSRP and RSRQ, RSRP and SINR, etc.) can be configured simultaneously for evaluating the CPC execution condition of a single candidate PSCell.

Before any CPC execution condition is satisfied, upon reception of a PSCell change command or PCell change command, the UE executes the PSCell change procedure as described in clauses 10.3 and 10.5 of TS 38.300 or the PCell change procedure as described in clause 9.2.3.2 of TS 36.300 or clause 10.1.2.1 of TS 38.300. Upon successful completion of the PSCell change or PCell change procedure, the UE releases all stored CPC configurations. During CPC execution, the UE is not required to continue evaluating the execution conditions of other candidate PSCells. Once the CPC procedure is executed successfully, the UE releases all stored CPC configurations. Upon the release of the SCG, the UE releases the stored CPC configurations.

3GPP Release 18 enhances CPC through selective activation of cell groups, where the UE does not release the stored CPC configuration for one or more candidate PSCells and the source PSCell based on network inputs. The UE may also store the CPA (Conditional PSCell Addition) configuration for one or more candidate PSCells.

The MN adds PSCell during a PSCell addition procedure. A PSCell addition procedure that is executed only when PSCell addition conditions are met is referred to as Conditional PSCell Addition (CPA). The PSCell change may be performed using a mobility procedure known as Lower Layer Triggered Mobility (LTM) in Release 18. The UE performs LTM for SCG upon receiving a MAC CE message known as LTM CellSwitchCommand and switches to an SCG cell for which it has received an LTM candidate cell configuration.

The mobility robustness optimization is to detect a sub-optimal successful PSCell change, or sub-optimal successful PSCell addition event.

| | |
|---|---|
| SuccessPSCell-Report-r18 ::= | SEQUENCE { |
| pCellId-r18 | CGI-Info-Logging-r16, |
| sourcePSCellInfo-r18 | SEQUENCE { |
| sourcePSCellId-r18 | CGI-Info-Logging-r16, |

| | |
|---|---|
| sourcePSCellMeas-r18 | MeasResultSuccessHONR-r17 |

OPTIONAL

| | |
|---|---|
| } | OPTIONAL, |

| | |
|---|---|
| targetPSCellInfo-r18 | SEQUENCE { |
| targetPSCellId-r18 | CHOICE { |
| cellGlobalId-r18 | CGI-Info-Logging-r16, |
| pci-arfcn-r18 | PCI-ARFCN-NR-r16 |

},

| | |
|---|---|
| targetPSCellMeas-r18 | MeasResultSuccessHONR-r17 |

OPTIONAL
},

| | |
|---|---|
| measResultNeighCells-r18 | SEQUENCE { |

| | |
|---|---|
| measResultListNR-r18 | MeasResultList2NR-r16 |

OPTIONAL,

| | |
|---|---|
| measResultListEUTRA-r18 | MeasResultList2EUTRA-r16 |

OPTIONAL

| } | | OPTIONAL, |
|---|---|---|
| spr-Cause-r18 | SPR-Cause-r18 | OPTIONAL, |

| | |
|---|---|
| timeSinceCPAC-Reconfig-r18 | TimeSinceCPAC-Reconfig-r18 |

OPTIONAL,

| | | |
|---|---|---|
| locationInfo-r18 | LocationInfo-r16 | OPTIONAL, |

| | |
|---|---|
| ra-InformationCommon-r18 | RA-InformationCommon-r16 |

OPTIONAL,

| | |
|---|---|
| sn-InitiatedPSCellChange-r18 | ENUMERATED {true} |

```
OPTIONAL,
  ...
  }
```

| | |
|---|---|
| MeasResultNeighFreqList-RSSI-r18 ::= | SEQUENCE(SIZE (1 .. maxFreq)) |

OF MeasResultNeighFreq-RSSI-r18
MeasResultNeighFreq-RSSI-r18 ::= SEQUENCE {

| | |
|---|---|
| ssbFrequency-r18 | ARFCN-ValueNR |

OPTIONAL,

| | |
|---|---|
| refFreqCSI-RS-r18 | ARFCN-ValueNR |

OPTIONAL,

| | |
|---|---|
| measResult-RSSI-r18 | RSSI-Range-r16 |

```
OPTIONAL
  }
  The Network configures the UE for reporting SPR using OtherConfig as given
below using RRC messages such as RRCReconfiguration in NR.
```

| | |
|---|---|
| OtherConfig-v1800 ::= | SEQUENCE { |

| | |
|---|---|
| idc-AssistanceConfig-v1800 | SetupRelease {IDC-AssistanceConfig- |

v1800} OPTIONAL, -- Need M

| | |
|---|---|
| multiRx-PreferenceReportingConfigFR2-r18 | SetupRelease {MultiRx- |

PreferenceReportingConfigFR2-r18} OPTIONAL, -- Need M

| | |
|---|---|
| uav-FlightPathAvailabilityConfig-r18 | ENUMERATED {true} |

OPTIONAL, -- Need R

| | |
|---|---|
| ul-TrafficInfoReportingConfig-r18 | SetupRelease {UL- |

TrafficInfoReportingConfig-r18} OPTIONAL, -- Need M

| | |
|---|---|
| n3c-RelayUE-InfoReportConfig-r18 | ENUMERATED {true} |

OPTIONAL, -- Need R

| | |
|---|---|
| successPSCell-Config-r18 | SetupRelease {SuccessPSCell-Config- |

r18} OPTIONAL, -- Need M

| | |
|---|---|
| sn-InitiatedPSCellChange-r18 | ENUMERATED {true} |

OPTIONAL, -- Need M

| | |
|---|---|
| musim-GapPriorityAssistanceConfig-r18 | ENUMERATED {true} |

OPTIONAL, -- Cond musimGapConfig

| | |
|---|---|
| musim-CapabilityRestrictionConfig-r18 | SetupRelease {MUSIM- |

CapabilityRestrictionConfig-r18} OPTIONAL -- Need M
}

Therefore, sn-InitiatedPSCellChange is provided as a Need M parameter, which means that when a UE has received an OtherConfig including sn-InitiatedPSCellChange, it retains the value. If the parameter receives another RRCReconfiguration message without sn-InitiatedPSCellChange, it applies the value received in the previous RRCReconfiguration message.

Hence, SPR contents may comprise SuccessPSCell-Report field descriptions. The measResultListNR field refers to the recent measurement results, according to the initiating node configuration, taken in the neighboring NR Cells when a successful PSCell change or addition is executed.

The pCellId field is used to indicate the PCell to which the UE was connected when the successful PSCell change or addition triggered the SuccessPSCell-Report. The sn-InitiatedPSCellChange field indicates whether the PSCell change procedure, for which the successful PSCell change report is logged, was SN initiated or not. The spr-Cause field is used to indicate the cause of the successful PSCell change or addition report.

The sourcePSCellId field is used to indicate the source PSCell of a PSCell change in which the successful PSCell change triggered the SuccessPSCell-Report. The sourcePSCellMeas field refers to the most recent measurement results taken in the source PSCell of the PSCell change that triggered the successful PSCell change SuccessPSCell-Report.

The targetPSCellId field is used to indicate the target PSCell of the PSCell change or addition in which the successful PSCell change or addition triggered the SuccessPSCell-Report.

The targetPSCellMeas field refers to the most recent measurement results taken in the target PSCell of a PSCell change or addition that triggered the successful PSCell change or addition SuccessPSCell-Report.

The timeSinceCPAC-Reconfig field indicates the time elapsed between the initiation of the last conditional reconfiguration execution toward the target PSCell and the reception of the latest conditional reconfiguration for the target PSCell. The actual value is calculated as field value*100 ms. The maximum value of 1023 means 102.3 seconds or longer.

Actions performed for the successful PSCell change or addition report determination is mentioned in 5.7.10.7 of TS 38.331

3gpp V17.6.0 version of TS 38.331, TS 38.321, TS 38.300 and TS 38.304 and 3gpp CR R2-2313855 which introduces SON/MDT features in Rel-18 and 3gpp CR R2-2313672 which introduces further mobility enhancements in Rel-18 can be considered as relevant background herein.

Hence, there is a need in the art for solutions which will overcome the above-mentioned drawback(s), among others.

Embodiments herein disclose methods and systems for managing Successful Primary SCG Cell (PSCell) Addition or Change Reports (SPR) in a wireless communication network. Further embodiments herein relate to providing self-optimization such as optimization for minimizing drive tests of random access in a wireless communication network.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

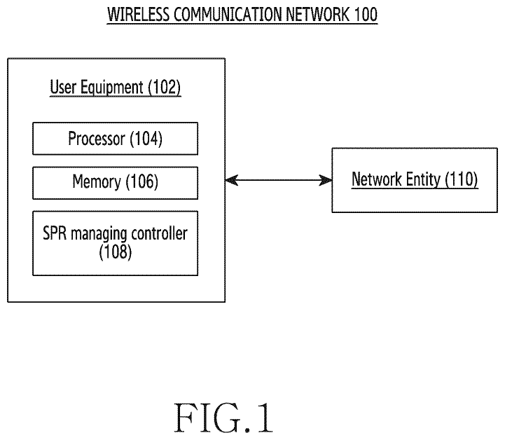

Referring now to the drawings, and more particularly to FIGS. 1 through 9, where similar reference characters denote corresponding features consistently throughout the figures, there are shown at least one embodiment.

FIG. 1 is an example block diagram depicting the communication of a User Equipment (UE) 102 and a network entity 110 for managing Successful Primary SCG Cell (PSCell) Addition or Change Reports in a wireless communication network 100 according to an embodiment of the disclosure.

Referring to FIG. 1, the wireless communication network 100 comprises the UE 102 and the network entity 110. The UE 102 comprises a processor 104, a memory 106, and a SPR managing controller 108. The UE 102 communicates with the network entity 110.

The UE 102 referred to herein may be an electronic device/user device that is used by the user to connect, interact, and/or control the operations of the plurality of other devices using a 3GPP network. Examples of the UE 102 may include, but are not limited to, a smartphone, a mobile phone, a video phone, a computer, a tablet personal computer (PC), a laptop, a wearable device, a personal digital assistant (PDA), an IoT device, or any other device that may use a 3GPP network or non-3GPP network.

The processor 104 may include one or a plurality of processors. The one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The memory 106 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The network entity 110 may represent a network element that communicates with the User Equipment (UE) 102. The network entity 110 sends configuration messages (such as RRCReconfiguration message) that include instructions for handling PSCell changes, additions, and SPR management. The network entity 110 can trigger the logging of SPR and provide parameters like ObtainCommonLocation.

In an embodiment, the UE 102 receives a configuration message comprising a configuration to report at least one of a successful PSCell change information and a successful PSCell addition information to the network entity 110. The UE 102 logs the at least one SPR on performing at least one of the successful PSCell change and the successful PSCell Addition. The UE 102 determines that at least one de-registration request is to be initiated or received from the network entity 110. The UE 102 discards the at least one logged SPR based on the at least one de-registration request, wherein the SPR comprises information associated with the at least one of the successful PSCell change and the successful PSCell addition.

The configuration message comprises the configuration to have a detailed location information available using a Global Navigation Satellite System (GNSS). The configuration for logging GNSS information is usually provided in measurement configuration such as report configuration. For e.g. includeCommonLocationInfo in the reportConfig informs the UE to report the location information in the measurement reports. In addition, the UE may receive an instruction for obtaining common Location for the measurements, for e.g. obtainCommonLocation. The at least one de-registration request is initiated by the UE 102 or triggered at the network entity 110. The UE 102 logs available detailed location information in the SPR if the obtainCommonLocation is received for an associated cell group. The UE 102 includes information in the Successful PSCell Change or Addition Report (SPR) including whether the UE 102 has derived timing advance using UE-based timing advance during an execution of the successful PSCell change or successful PSCell addition.

The UE 102 receives an RRCReconfiguration message comprising an OtherConfig field. The UE 102 may determine whether the OtherConfig field comprises a secondary node (SN)-InitiatedPSCellChnage parameter. The UE 102 releases SN-InitiatedPSCellChange in response to determining that the OtherConfig field does not comprise the SN-InitiatedPSCellChange parameter. The SN-InitiatedPSCellChange parameter is configured as a Need R parameter.

Another embodiment as disclosed herein, the SPR managing controller 108 is configured to receive the configuration message comprising a configuration to report at least one of: the successful PSCell change information and the successful PSCell addition information to the network entity 110. The SPR managing controller 108 can log the at least one SPR upon performing at least one of: the successful PSCell change and the successful PSCell Addition. The SPR managing controller 108 determines that at least one de-registration request is to be initiated or received from the network entity 110. The SPR managing controller 108 can discard the at least one logged SPR based on the at least one de-registration request, wherein the SPR includes information associated with at least one of: the successful PSCell change and the successful PSCell addition. Discarding the SPR based on deregistration is helpful for both the network and it allows the UE to keep only relevant information for optimizing dual connectivity. It also allows the UE store the SPR in the volatile memory, reducing the overall cost of the UEs. For the network, it avoids receiving the stale reports, saving signaling and processing overheads. For e.g. the network may consider that the UE has overstayed in the network, like a UE has subscription for three months and the subscription period has exceeded. So, the network may initiate deregistration procedure and any SPR from this UE may be considered stale. Keeping the stale SPR including stale information till network retrieves it or till the UE detaches (by power-off or after an Inter-RAT transition) is an unnecessary overhead.

In an embodiment, the UE 102 informs the network entity 110 whether PSCellChange or addition is RACHless or not in the SCGFailureInformation. In an embodiment, the UE 102 includes an information whether UE 102 has derived timing advance using UE 102 based Timing Advance during successful PSCellChange or Addition execution in the SPR or SCGFailureInformation. In an embodiment herein, this may be informed for LTM.

The UE 102 communicates additional details about PSCellChange or PSCell Addition to the network in specific scenarios which may include, but not limited to Random Access Channel free (RACHless) execution status, timing advance information, and relevance for Lower Layer Triggered Mobility (LTM). RACHless refers to a RACH free operation, meaning the UE 102 performs PSCellChange or Addition without using the RACH procedure.

Hence, the UE 102 informs the network entity 110 whether PSCellChange or Addition was RACHless, helps the network distinguish faster RACH-free executions. The UE 102 reports UE-based Timing Advance, if derived locally during PSCellChange or Addition execution. The details are included in reports like SCGFailureInformation and SPR. For Lower Layer Triggered Mobility (LTM), the reports provide additional context to the network entity 110, aiding in the optimization of mobility management at lower protocol layers.

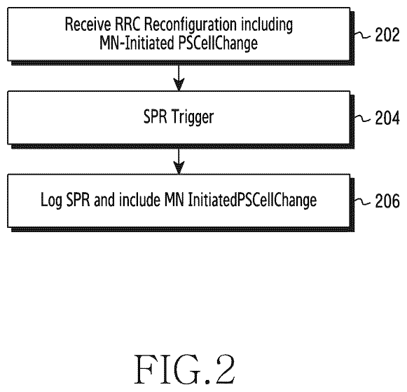

FIG. 2 is an example diagram illustrating the method of Master Node (MN) initiated Primary SCG Cell (PSCellChange) configuration and reporting according to an embodiment of the disclosure.

Referring to FIG. 2, in operation 202, a User Equipment (UE) 102 receives a RRC Reconfiguration message with a Master Node (MN)-InitiatedPSCellChange parameter. The UE 102 on receiving the RRC Reconfiguration message with the MN-InitiatedPSCellChange parameter, which signifies that the PSCell change or addition is initiated by the MN. Once the UE 102 processes the RRC Reconfiguration message, an SPR trigger condition is satisfied. In operation 204, the SPR trigger condition is pre-defined, involving specific network or UE 102 events, such as successful PSCell change or addition. Hence, in operation 206, the UE 102 logs the Successful PSCell Change or Addition Report (SPR), The logged SPR comprises the information associated with the MN-InitiatedPSCellChange configuration, as defined in the network.

Hence, the inclusion of the MN-InitiatedPSCellChnage parameter in the SPR log ensures accurate recording of network-driven PSCell operations. The release and logging process improves SPR management and reduces unnecessary retention of configurations, thereby optimizing UE memory usage.

In an embodiment as disclosed herein, a network node (such as gNB) informs the UE 102 if the Reconfiguration message triggering Reconfiguration WithSync for a PSCellChange is MN initiated using an enumerated value (i.e., a flag). In NR, the gNB may include a field (e.g. MN-InitiatedPSCellChange) in OtherConfig. If field MN-InitiatedPSCellChange) is included (i.e., if the field is set as true), the UE 102 identifies that the PSCellChange is MN initiated. On the other hand, if the field is not included, the UE 102 identifies the PSCell change as Secondary Node (SN) initiated.

In an embodiment, if the UE 102 has received MN-InitiatedPSCellChange from the network entity 110 in the RRC Reconfiguration message which triggers PSCellChange, the UE 102 informs the network that the PSCellChange is MN initiated. The UE 102 includes an enumerated value MN-InitiatedPSCellChange in the SPR and sets the value of MN-InitiatedPSCellChange to true to inform the network that the PSCellChange is MN initiated. In an embodiment, if the UE 102 has not received MN-InitiatedPSCellChange from the network in RRC Reconfiguration message which triggers PSCellChange, the UE 102 does not include MN-InitiatedPSCellChange in the SPR.

The UE 102 includes the field MN-InitiatedPSCellChange, based on whether the MN-InitiatedPSCellChange is received.

In an embodiment, MN-InitiatedPSCellChange is provided as a Need R parameter, which means a UE 102 which has received an OtherConfig including MN-InitiatedPSCellChange does not maintain the value, and if the UE 102 receives another RRCReconfiguration message without MN-InitiatedPSCellChange, it releases MN-InitiatedPSCellChange.

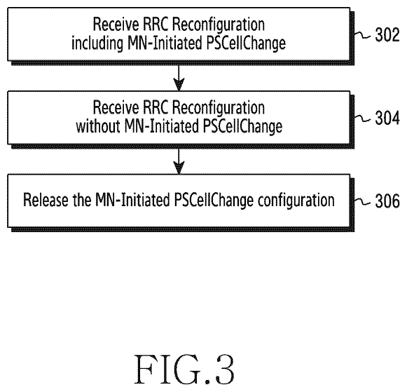

FIG. 3 is an example diagram illustrating the method of MN Initiated PSCellChange configuration handling in the wireless communication network, when the RRC Reconfiguration message is received by the UE 102 according to an embodiment of the disclosure.

Referring to FIG. 3, in operation 302, the UE 102 receives the RRC Reconfiguration message that includes the MN-InitiatedPSCellChange parameter. The configuration indicates that the PSCell change or addition process is initiated by the Master Node (MN). The UE 102 activates and stores the MN-InitiatedPSCellChange configuration as part of its operational state. In operation 304, the UE 102 receives another RRC Reconfiguration message, which does not include the MN-InitiatedPSCellChange parameter.

The absence of the parameter signifies that the network does not intend for the UE 102 to maintain the configuration. Operation 306, in response to the absence of the MN-InitiatedPSCellChange parameter, the UE 102 releases stored MN-InitiatedPSCellChange configuration. Thus, ensures that the UE 102 updates its configuration to align with the network's instructions.

Therefore, the UE 102 maintains only the necessary configurations for network operations, avoiding redundant or outdated states. By releasing the MN-InitiatedPSCellChange configuration when it is no longer required, the UE 102 optimizes memory and processing resources.

In another embodiment, the UE 102 is initially instructed to monitor and log PSCell changes via MN-InitiatedPSCellChange as part of its operational setup. The network entity 110 decides to deactivate (e.g., due to dynamic network conditions or a completed PSCell operation). The network entity 110 omits the MN-InitiatedPSCellChange parameter in the next RRC Reconfiguration message. The UE 102 promptly releases the stored MN-InitiatedPSCellChange configuration, ensuring its operational state is up-to-date.

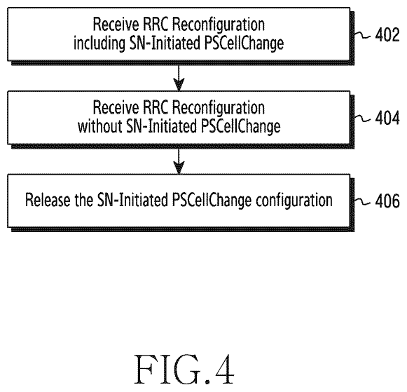

FIG. 4 is an example diagram illustrating the method of Secondary Node (SN) Initiated PSCellChange configuration handling according to an embodiment of the disclosure.

Referring to FIG. 4, the UE 102 manages the presence or absence of the SN-InitiatedPSCellChange parameter in consecutive RRC Reconfiguration messages and the subsequent actions taken by the UE 102 to update or release the configuration. In operation 402, the UE 102 receives an RRC Reconfiguration message that includes the SN-InitiatedPSCellChange parameter.

The parameter indicates that the PSCell change or addition process is initiated by the Secondary Node (SN). On receiving the message, the UE 102 activates and stores the SN-InitiatedPSCellChange configuration. In operation 404, the UE 102 receives another RRC Reconfiguration message, but the message does not include the SN-InitiatedPSCellChange parameter. The absence of the parameter signifies that the network entity 110 no longer intends for the UE 102 to maintain the SN-InitiatedPSCellChange configuration. Operation 406, in response to the absence of the SN-InitiatedPSCellChange parameter, the UE 102 releases the stored SN-InitiatedPSCellChange configuration. This ensures that UE doesn't log SPR based on any previous PSCellChange or PSCellAddition. This also simplifies the network implementation for the configuration of SN-InitiatedPSCellChange as the network doesn't have to send RRCReconfiguration message for releasing the sn-initiatedPSCellChange. This also saves signaling on the air interface and between the network nodes.

In an embodiment, sn-InitiatedPSCellChange can be provided as a Need R parameter, which means the UE 102 which has received an OtherConfig including sn-InitiatedPSCellChange does not maintain the value. If the UE 102 receives another RRCReconfiguration message without sn-InitiatedPSCellChange, the UE 102 releases sn-InitiatedPSCellChange and performs determination of SPR logging and the determination of contents of SPR as if there is no InitiatedPSCellChange received.

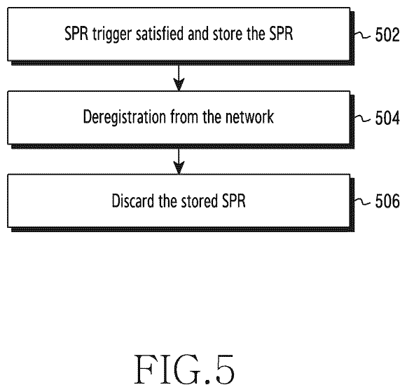

FIG. 5 is an example diagram illustrating the method for handling Successful Primary SCG Cell (PSCell) Addition or Change Reports (SPR) during de-registration according to an embodiment of the disclosure.

In operation 502, the specific event or condition occurs (such as the network has configured the UE to log SPR when the T310 or T312 or T304 timer value exceeds a T310/T312/T314 threshold configured by the network and the threshold has exceeded), for satisfying the SPR trigger for the UE 102. The trigger conditions may include, but not limited to a successful PSCell change (e.g., a new cell is added to the serving group or replaced as the primary SCG cell), a successful PSCell addition.

On satisfying the condition, the UE 102 logs and stores the SPR. The SPR comprise details about the PSCell operation, such as location information, signal measurements, and timing advance, as per network configuration. The logged SPR is stored in the UE's memory as part of the variable VarSuccessPSCell-Report.

Further, the UE 102 initiates or receives a deregistration request from the network. In operation 504, the deregistration can occur for several reasons, such as the UE 102 informs the network entity 110 it no longer wants to access services, the network entity 110 notifies the UE 102 that it no longer has access to services (e.g., due to location restrictions or service termination).

Therefore, in operation 504, upon deregistration, the UE 102 discards all stored SPR, which involves: releasing the VarSuccessPSCell-Report variable, removing logged details about successful PSCell changes or additions from memory. Thus, ensures that stale information is not retained after the UE 102 disconnects from the network.

In an embodiment, in operation 506, the UE 102 discards any logged SPR upon deregistering from the network. If the UE 102 has sent a de-registration request or if a network triggered de-registration is received, the UE 102 discards SPR. FIG. 5 depicts the method for handling SPR during de-registration.

In an embodiment as disclosed herein, MN-InitiatedPSCellChange is provided as a Need R parameter, which means the UE 102 which has received an OtherConfig including mn-InitiatedPSCellChange does not maintain the value, and if the UE 102 receives another RRCReconfiguration message without mn-InitiatedPSCellChange, it releases mn-InitiatedPSCellChange.

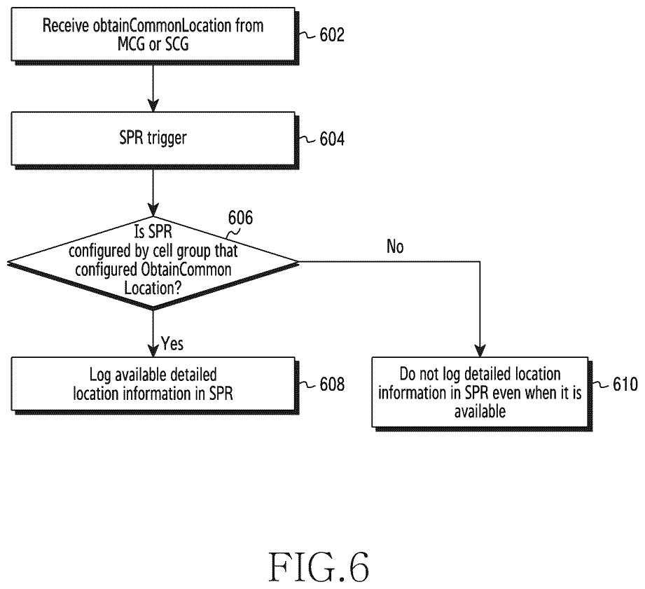

FIG. 6 is an example diagram illustrating the method for handling ObtainCommonLocation according to an embodiment of the disclosure.

Referring to FIG. 6, in operation 602, the UE 102 receives the ObtainCommonLocation parameter from either the Master Cell Group (MCG) or the Secondary Cell Group (SCG). In operation 604, the SPR is triggered. The ObtainCommonLocation parameter instructs the UE 102 to include detailed location information (e.g., GNSS-based location) in the SPR. In operation 606, the UE 102 evaluates whether the cell group (MCG or SCG) that configured the ObtainCommonLocation parameter is the same cell group that configured the SPR. The UE 102 on identifying if the cell group that configured the SPR also configured the ObtainCommonLocation. In operation 608, the UE 102 logs the available detailed location information in the SPR, else in operation 610 the UE 102 do not log detailed information in SPR, even it is available. Thereby, ensures compliance with network instructions and includes valuable data for network optimization. If the ObtainCommonLocation is not received from the specific node (MN or SN), it means that the node is not interested in receiving the location information, even though the measurement configuration such as report configuration maintained by the node has configuration to perform the location measurements. Configuration to perform the location measurements may be maintained to avoid additional downlink signaling for reconfiguration, but the ObtainCommonLocation controls the logging of locationinformation in the SPR. Additional control saves UE memory and the overall signaling of SPR. The UE 102 on identifying if the cell group that configured the ObtainCommonLocation is different from the cell group that configured the SPR, the UE 102 does not log detailed location information in the SPR, even if it is available. Therefore, prevents unnecessary or redundant logging.

For an instance, consider the UE 102 receives the ObtainCommonLocation parameter from the MCG. The SPR is also configured by the MCG. The UE 102 logs detailed location information (e.g., GNSS-based data) in the SPR. The UE 102 receives the ObtainCommonLocation parameter from the SCG. The SPR is configured by the MCG. The UE 102 does not log detailed location information in the SPR, even if the data is available. Therefore, by conditionally logging location information, the UE 102 prevents unnecessary data collection and storage, optimizing memory and processing resources.

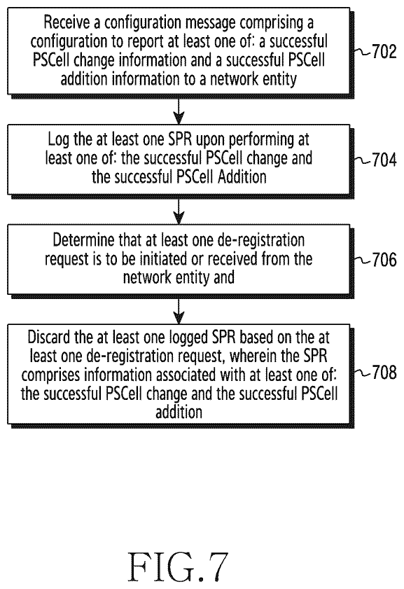

FIG. 7 is an example flow diagram for managing Successful Primary SCG Cell (PSCell) Addition or Change Reports (SPR) in the wireless communication network 100 according to an embodiment of the disclosure.

As illustrated in operation 702, the SPR managing controller 108, coupled with the processor 104 and the memory 106, configured to receive a configuration message comprising a configuration to report at least one of: a successful PSCell change information and a successful PSCell addition information to a network entity 110. In operation 704, the SPR managing controller 108 logs the at least one SPR upon performing at least one of: the successful PSCell change and the successful PSCell Addition. In operation 706, the SPR managing controller 108 determines that at least one de-registration request is to be initiated (i.e. by the UE) or received from the network entity 110. In operation 708, the SPR managing controller 108 discards the at least one logged SPR based on the at least one de-registration request, wherein the SPR comprises information associated with at least one of: the successful PSCell change and the successful PSCell addition.

In an embodiment, according to TS 38.331,

| | |
|---|---|
| OtherConfig-v1800 ::= | SEQUENCE { |

| | |
|---|---|
| idc-AssistanceConfig-v1800 | SetupRelease {IDC-AssistanceConfig- |

v1800} OPTIONAL, -- Need M

| | |
|---|---|
| multiRx-PreferenceReportingConfigFR2-r18 | SetupRelease {MultiRx- |

PreferenceReportingConfigFR2-r18} OPTIONAL, -- Need M

| | |
|---|---|
| uav-FlightPathAvailabilityConfig-r18 | ENUMERATED {true} |

OPTIONAL, -- Need R

| | |
|---|---|
| ul-TrafficInfoReportingConfig-r18 | SetupRelease {UL- |

TrafficInfoReportingConfig-r18} OPTIONAL, -- Need M

| | |
|---|---|
| n3c-RelayUE-InfoReportConfig-r18 | ENUMERATED {true} |

OPTIONAL, -- Need R

| | |
|---|---|
| successPSCell-Config-r18 | SetupRelease {SuccessPSCell-Config-r18} |

OPTIONAL, -- Need M

| | |
|---|---|
| mn-InitiatedPSCellChange-r18 | ENUMERATED {true} |

OPTIONAL, -- Need R

| | |
|---|---|
| musim-GapPriorityAssistanceConfig-r18 | ENUMERATED {true} |

OPTIONAL, -- Cond musimGapConfig

| | |
|---|---|
| musim-CapabilityRestrictionConfig-r18 | SetupRelease {MUSIM- |

CapabilityRestrictionConfig-r18}

| | |
|---|---|
| SuccessPSCell-Report-r18 ::= | SEQUENCE { |
| pCellId-r18 | CGI-Info-Logging-r16, |
| sourcePSCellInfo-r18 | SEQUENCE { |
| sourcePSCellId-r18 | CGI-Info-Logging-r16, |

| | |
|---|---|
| sourcePSCellMeas-r18 | MeasResultSuccessHONR-r17 |

OPTIONAL

| | |
|---|---|
| } | OPTIONAL, |

| | |
|---|---|
| targetPSCellInfo-r18 | SEQUENCE { |
| targetPSCellId-r18 | CHOICE { |
| cellGlobalId-r18 | CGI-Info-Logging-r16, |
| pci-arfcn-r18 | PCI-ARFCN-NR-r16 |

},

| | |
|---|---|
| targetPSCellMeas-r18 | MeasResultSuccessHONR-r17 |

OPTIONAL
},

| | |
|---|---|
| measResultNeighCells-r18 | SEQUENCE { |

| | |
|---|---|
| measResultListNR-r18 | MeasResultList2NR-r16 |

OPTIONAL,

| | |
|---|---|
| measResultListEUTRA-r18 | MeasResultList2EUTRA-r16 |

OPTIONAL

| } | | OPTIONAL, |
|---|---|---|
| spr-Cause-r18 | SPR-Cause-r18 | OPTIONAL, |

| | |
|---|---|
| timeSinceCPAC-Reconfig-r18 | TimeSinceCPAC-Reconfig-r18 |

OPTIONAL,

| | | |
|---|---|---|
| locationInfo-r18 | LocationInfo-r16 | OPTIONAL, |

| | |
|---|---|
| ra-InformationCommon-r18 | RA-InformationCommon-r16 |

OPTIONAL,

| | |
|---|---|
| mn-InitiatedPSCellChange-r18 | ENUMERATED {true} |

```
OPTIONAL,
  ...
  }
```

### SuccessPSCell-Report Field Descriptions:

The measResultListNR field refers to the last measurement results according to the initiating node configuration taken in the neighboring NR Cells when a successful PSCell change/addition is executed.

The pCellId field is used to indicate the PCell to which the UE 102 was connected when the successful PSCell change, or addition triggers the SuccessPSCell-Report.

The mn-InitiatedPSCellChange field indicates whether the PSCell change procedure for which the successful PSCell change report is logged is MN initiated or not.

The spr-Cause field is used to indicate the cause of the successful PSCell change or addition report.

The sourcePSCellId field is used to indicate the source PSCell of a PSCell change in which the successful PSCell change triggers the SuccessPSCell-Report.

The sourcePSCellMeas field refers to the last measurement results taken in the source PSCell of a PSCell change in which the successful PSCell change triggers the SuccessPSCell-Report.

The targetPSCellId field is used to indicate the target PSCell of a PSCell change/addition in which the successful PSCell change, or addition triggers the SuccessPSCell-Report.

The targetPSCellMeas field refers to the last measurement results taken in the target PSCell of a PSCell change/addition in which the successful PSCell change or addition triggers the SuccessPSCell-Report.

The timeSinceCPAC-Reconfig field is used to indicate the time elapsed between the initiation of the last conditional reconfiguration execution towards the target PSCell and the reception of the latest conditional reconfiguration for this target PSCell. Actual value=field value*100 ms. The maximum value 1023 means 102.3 s or longer.

The OtherConfig may refer to mn-InitiatedPSCellChange field indicates whether the PSCell change procedure included in the RRCReconfiguration message is MN initiated or not.

### 5.7.10.7 Actions for the Successful PSCell Change or Addition Report Determination

### The UE for the PSCell:

1> if the ratio between the value of the elapsed time of the timer T304 and the configured value of the timer T304, included in the last applied RRCReconfiguration message for the SCG including the reconfiguration WithSync, is greater than thresholdPercentageT304-SCG if included in the successPSCell-Config received before executing the last reconfiguration with sync for the SCG; or
1> if mn-InitiatedPSCellChange is not configured in the RRCReconfiguration including the last applied RRCReconfiguration with reconfiguration WithSync for the SCG and if the ratio between the value of the elapsed time of the timer T310 and the configured value of the timer T310, configured while the UE 102 was connected to the source PSCell before executing the last reconfiguration with sync for the SCG, is greater than thresholdPercentageT310-SCG included in the successPSCell-Config if configured by the source PSCell before executing the last reconfiguration with sync; or
1> if mn-InitiatedPSCellChange is not configured in the RRCReconfiguration including the last applied RRCReconfiguration with reconfiguration WithSync for the SCG and if the T312 associated to the measurement identity of the target PSCell was running at the time of initiating the execution of the reconfiguration with sync procedure for the SCG and if the ratio between the value of the elapsed time of the timer T312 and the configured value of the timer T312, configured while the UE 102 was connected to the source PSCell before executing the last reconfiguration with sync, is greater than thresholdPercentageT312-SCG included in the successPSCell-Config if configured by the source PSCell before executing the last reconfiguration with sync:
1> if mn-InitiatedPSCellChange is configured in the RRCReconfiguration including the last applied RRCReconfiguration with reconfiguration WithSync for the SCG and if the ratio between the value of the elapsed time of the timer T310 and the configured value of the timer T310, configured while the UE 102 was connected to the source PSCell before executing the last reconfiguration with sync for the SCG, is greater than thresholdPercentageT310-SCG included in the successPSCell-Config if configured by the PCell before executing the last reconfiguration with sync; or
1> if mn-InitiatedPSCellChange is configured in the RRCReconfiguration including the last applied RRCReconfiguration with reconfiguration WithSync for the SCG and if the T312 associated to the measurement identity of the target PSCell was running at the time of initiating the execution of the reconfiguration with sync procedure for the SCG and if the ratio between the value of the elapsed time of the timer T312 and the configured value of the timer T312, configured while the UE 102 was connected to the source PSCell before executing the last reconfiguration with sync, is greater than thresholdPercentageT312-SCG included in the successPSCell-Config if configured by the PCell before executing the last reconfiguration with sync:
2> clear the information included in VarSuccessPSCell-Report, if any;
2> store the successful PSCell change or addition information in VarSuccessPSCell-Report and determine the content in VarSuccessPSCell-Report as follows:
3> if the UE 102 is not in SNPN access mode, set the plmn-IdentityList to include the list of EPLMNs stored by the UE (i.e., includes the RPLMN);
3> else if the UE is in SNPN access mode, set the snpn-IdentityList to include the list of equivalent SNPNs stored by the UE (i.e., includes the registered SNPN), if available;
3> set the pCellId to the global cell identity and tracking area code, if available, of the PCell;
3> for the source PSCell (if available) in which the last RRCReconfiguration message for the SCG including reconfiguration WithSync was applied:
4> set the sourcePSCellId in sourcePSCellInfo to the global cell identity and tracking area code, of the source PSCell;
4> set the sourcePSCellMeas in sourcePSCellInfo to include the cell level RSRP, RSRQ and the available SINR, of the source PSCell based on the available SSB and CSI-RS measurements collected up to the moment the UE successfully completed the random-access procedure for the SCG;
4> set the rsIndexResults in sourceCellMeas to include all the available SSB and CSI-RS measurement quantities of the source PSCell collected up to the moment the UE successfully completed the random-access procedure for the SCG;
3> for the target PSCell indicated in the last applied RRCReconfiguration message for the SCG including reconfiguration WithSync:
4> set the targetPSCellID in targetPSCellInfo to the global cell identity and tracking area code, if available, and otherwise to the physical cell identity and carrier frequency of the target PSCell;
4> set the targetPSCellMeas in targetPSCellInfo to include the cell level RSRP, RSRQ and the available SINR, of the target PSCell based on the available SSB and CSI-RS measurements collected up to the moment the UE successfully completed the random-access procedure for the SCG;
4> set the rsIndexResults in targetCellMeas to include all the available SSB and CSI-RS measurement quantities of the target PSCell collected up to the moment the UE successfully completed the random-access procedure for the SCG;
4> if the last applied RRCReconfiguration message for the SCG including reconfiguration WithSync was included in the stored condRRCReconfig:
5> set the timeSinceCPAC-Reconfig to the time elapsed between the initiation of the execution of conditional reconfiguration for the target PSCell and the reception of the last conditionalReconfiguration for the SCG including the condRRCReconfig of the target PSCell;
3> if the ratio between the value of the elapsed time of the timer T304 and the configured value of the T304 timer, included in the last applied RRCReconfiguration message for the SCG including the reconfigurationWithSync, is greater than thresholdPercentageT304-SCG if included in the successPSCell-Config received before executing the last reconfiguration with sync for the SCG:
4> set t304-cause in spr-Cause to true;
4> set the ra-InformationCommon to include the random-access related information associated to the random-access procedure in the target PSCell, as specified in clause 5.7.10.5;
3> if the ratio between the value of the elapsed time of the timer T310 and the configured value of the timer T310, configured while the UE was connected to the source PSCell before executing the last reconfiguration with sync for the SCG, is greater than thresholdPercentageT310-SCG included in the successPSCell-Config if configured before executing the last reconfiguration with sync:
4> set t310-cause in spr-Cause to true;
3> if the T312 associated to the measurement identity of the target PSCell was running at the time of initiating the execution of the reconfiguration with sync procedure for the SCG and if the ratio between the value of the elapsed time of the timer T312 and the configured value of the timer T312, configured while the UE was connected to the source PSCell before executing the last reconfiguration with sync, is greater than thresholdPercentageT312-SCG included in the successPSCell-Config if configured before executing the last reconfiguration with sync:
4> set t312-cause in spr-Cause to true;
3> if mn-InitiatedPSCellChange is not configured in the RRCReconfiguration including the last applied RRCReconfiguration with reconfiguration WithSync for the SCG:
4> consider all measObjectNR configured by the source PSCell;
3> else:
4> consider all measObjectNR configured by the PCell;
3> for each of the measObjectNR:
4> if measurements are available for the measObjectNR:
5> if the SS/PBCH block-based measurement quantities are available:
6> include in the measResultListNR in measResultNeighCells all the available measurement quantities of the best measured cells, other than the source PCell or target PCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE successfully completed the random access procedure;
6> for each neighbour cell included, include the optional fields that are available (including the CSI-RS based measurement quantities, if available);
5> if the CSI-RS measurement quantities are available for the cells not yet included in measResultListNR in measResultNeighCells:
6> include in the measResultListNR in measResultNeighCells all the available measurement quantities of the best measured cells, other than the source PCell and target PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE successfully completed the random access procedure;
6> for each neighbour cell included, include the optional fields that are available;
3> for each of the neighbour cells included in measResultNeighCells:
4> if the cell was a candidate target cell included in the condRRCReconfig within the conditionalReconfiguration, in which the last RRCReconfiguration message for the SCG including reconfiguration WithSync was applied:
5> set the choCandidate to true in measResultNR;
3> include mn-InitiatedPSCellChange if mn-InitiatedPSCellChange is included in the RRCReconfiguration including the applied RRCReconfiguration message with reconfiguration WithSync for the SCG;
3> if mn-InitiatedPSCellChange is not configured in the RRCReconfiguration including the last applied RRCReconfiguration with reconfiguration WithSync for the SCG:
4> if available, set the locationInfo as in 5.3.3.7 7 according to the otherConfig associated with the source PSCell;
3> else:
4> if available, set the locationInfo as in 5.3.3.7 7 according to the otherConfig associated with the PCell;
1> release successPSCell-Config configured by the source PSCell if available and thresholdPercentageT304 if configured by the target PSCell.

The UE 102 may discard the successful PSCell change or addition information, i.e., release the UE 102 variable VarSuccessPSCell-Report, 48 hours after the last successful PSCell change or addition information is added to the VarSuccessPSCell-Report or upon deregistering from the network entity 110.

In an embodiment, the UE 102 which receives the field obtainCommonLocation (which informs the UE 102 to attempt to have detailed location information available using GNSS) verifies if the obtainCommonLocation is received for MCG or SCG (as depicted in FIG. 6). In an embodiment, the UE 102 includes available detailed location information for any successful PSCell change or addition report, which is associated (or for which the configuration is associated) with the cell group which configured ObtainCommmonLocation. In an example, if ObtainCommmonLocation is configured by the MCG and the SPR is associated with SCG, the UE 102 may not log the location information even if it is available. Similarly, if ObtainCommmonLocation is configured by SCG and the SPR is associated with MCG, the UE 102 may not log the location information even if it is available. But if ObtainCommmonLocation is configured by the MCG and the SPR is associated with MCG, the UE 102 will log the location information if it is available. Similarly, if ObtainCommmonLocation is configured by SCG and the SPR is associated with SCG, the UE 102 will log the location information if it is available

In an embodiment, if the obtainCommonLocation is received in a RRCReconfiguration message received in SRB3, and ObtainCommmonLocation is configured by the SCG. In an embodiment, if the obtainCommonLocation is contained in a SCG RRCReconfiguration message received as embedded in an MN RRCReconfiguration message, and ObtainCommmonLocation is configured by the SCG. In an embodiment, if the obtainCommonLocation is contained in an MCG RRCReconfiguration message, and ObtainCommmonLocation is configured by the MCG.

In an embodiment, if the obtainCommonLocation is contained in the MCG RRCReconfiguration message carrying the SCG RRCReconfiguration message such as SCG RRCReconfiguration message including ReconfigurationWithSync and mn-InitiatedPSCellChange is included, ObtainCommmonLocation is configured by the MCG. In an embodiment, if the obtainCommonLocation is contained in an MCG RRCReconfiguration message carrying the SCG RRCReconfiguration message such as SCG RRCReconfiguration message including Reconfiguration WithSync and mn-InitiatedPSCellChange is not included, ObtainCommmonLocation is configured by the SCG.

In an embodiment, if the obtainCommonLocation is contained in the MCG RRCReconfiguration message carrying a SCG RRCReconfiguration message such as SCG RRCReconfiguration message including Reconfiguration WithSync and sn-InitiatedPSCellChange is included, ObtainCommmonLocation is configured by the SCG. In an embodiment, if the obtainCommonLocation is contained in the MCG RRCReconfiguration message carrying the SCG RRCReconfiguration message such as SCG RRCReconfiguration message including Reconfiguration WithSync and mn-InitiatedPSCellChange is not included, ObtainCommmonLocation is configured by the MCG.

In an embodiment, the UE 102 includes an information whether successful PSCellChange or Addition is RACHless or not (i.e., whether random access was performed for (completing) the successful PSCellChange or Addition) in the SPR. In an embodiment herein, this may be performed for mobility in Non-Terrestrial Networks (NTN) or LTM.

In an embodiment, the UE 102 informs the network entity 110 whether PSCellChange or addition is RACHless or not in the SCGFailureInformation.

In an embodiment, the UE 102 includes an information whether UE 102 has derived timing advance using UE 102 based Timing Advance during successful PSCellChange or Addition execution in the SPR or SCGFailureInformation. In an embodiment herein, this may be informed for LTM.

In an embodiment, the UE 102 includes an information whether the UE 102 has sent the complete message (such as NR RRCReconfigurationComplete) during successful PSCellChange or Addition execution using SRB1, in the SPR or SCGFailureInformation. In an embodiment herein, this may be informed for LTM.

In an embodiment herein, the UE 102 includes an information whether UE 102 has sent the complete message (such as NR RRCReconfigurationComplete) during successful PSCellChange or Addition execution using SRB3, in the SPR or SCGFailureInformation. In an embodiment this may be informed for LTM.

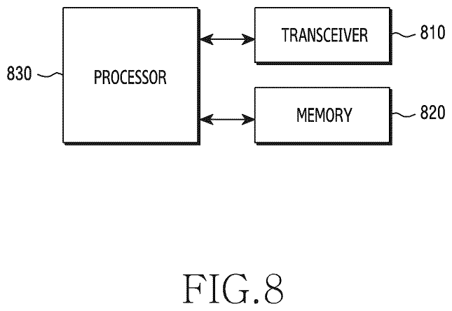

FIG. 8 illustrates a block diagram illustrating a structure of a UE according to an embodiment of the disclosure.

Referring to FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor.

The transceiver 810 collectively refers to a UE receiver and a UE transmitter, and may transmit/receive a signal to/from a base station. The signal transmitted or received to or from the base station may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station, and the processor 830 may determine a result of receiving the control signal and the data signal transmitted by the base station.

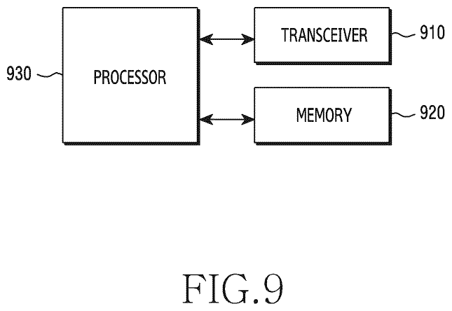

FIG. 9 illustrates a block diagram illustrating a structure of a base station according to an embodiment of the disclosure.

Referring to FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor.

The transceiver 910 collectively refers to a base station receiver and a base station transmitter, and may transmit/receive a signal to/from a terminal. The signal transmitted or received to or from the terminal may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe a circuit for performing analog calibration for a scalable multi-voltage memory interface driver. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. A user equipment (UE) in a wireless communication system, the UE comprising:
a transceiver; and
a controller coupled with the transceiver, and configured to:
store first information on a successful primary secondary cell group (SCG) cell (PSCell) change or addition,
transmit, to a base station, a message including a report for the successful PSCell change or addition,
perform a deregistration procedure from a network, and
upon the deregistration procedure, discard the first information on the successful PSCell change or addition.

2. The UE of claim 1, wherein the deregistration procedure is initiated by one of the UE or the network.

3. The UE of claim 1, wherein the first information on the successful PSCell change or addition is a variable VarSuccessPSCell-Report.

4. The UE of claim 1,
wherein the controller is further configured to:
receive, from the base station, second information for requesting the UE to attempt to have detailed location information available using a global navigation satellite system (GNSS), and
wherein, in case that the second information is associated with a cell group which is associated with the successful PSCell change or addition, the second information includes available detailed location information.

5. The UE of claim 4, wherein the second information is obtainCommonLocation information.

6. The UE of claim 1,
wherein the controller is further configured to:
receive, from the base station, a first radio resource control (RRC) reconfiguration message including an indicator indicating whether a PSCell change procedure is initiated by a secondary node (SN), and
receive, from the base station, a second RRC reconfiguration message, and
wherein, in case that the second RRC reconfiguration message does not include the indicator, configuration information for the successful PSCell change or addition associated with the first RRC reconfiguration is released.

7. The UE of claim 6, wherein the indicator is sn-initiatedPSCellChange information.

8. A method performed by a user equipment (UE) in a wireless communication system, the method comprising:
storing first information on a successful primary secondary cell group (SCG) cell (PSCell) change or addition;
transmitting, to a base station, a message including a report for the successful PSCell change or addition;
performing a deregistration procedure from a network; and
upon the deregistration procedure, discarding the first information on the successful PSCell change or addition.

9. The method of claim 8, wherein the deregistration procedure is initiated by one of the UE or the network.

10. The method of claim 8, wherein the first information on the successful PSCell change or addition is a variable VarSuccessPSCell-Report.

11. The method of claim 8, further comprising:
receiving, from the base station, second information for requesting the UE to attempt to have detailed location information available using a global navigation satellite system (GNSS),
wherein, in case that the second information is associated with a cell group which is associated with the successful PSCell change or addition, the second information includes available detailed location information.

12. The method of claim 11, wherein the second information is obtainCommonLocation information.

13. The method of claim 8, further comprising:
receiving, from the base station, a first radio resource control (RRC) reconfiguration message including an indicator indicating whether a PSCell change procedure is initiated by a secondary node (SN); and
receiving, from the base station, a second RRC reconfiguration message,
wherein, in case that the second RRC reconfiguration message does not include the indicator, configuration information for the successful PSCell change or addition associated with the first RRC reconfiguration is released.

14. The method of claim 13, wherein the indicator is sn-initiatedPSCellChange information.
